(19) United States
(12) Patent Application Publication
(10) Pub. No.: US 2014/0240859 A1
(43) Pub. Date: Aug. 28, 2014

(54) OPTIC OBSCURATION ASSEMBLY, METHOD AND SYSTEM FOR WORKING ON AN OPTICAL ELEMENT, AND RESULTING OPTICAL ELEMENT

(71) Applicant: CORNING INCORPORATED, Corning, NY (US)

(72) Inventors: Glenn A. Parker, Lima, NY (US); Kevin J. Magierski, Victor, NY (US); Brian Monroe McMaster, Pittsford, NY (US)

(73) Assignee: CORNING INCORPORATED, Corning, NY (US)

(21) Appl. No.: 13/957,635

(22) Filed: Aug. 2, 2013

Related U.S. Application Data
(60) Provisional application No. 61/770,515, filed on Feb. 28, 2013.

(51) Int. Cl. B25B 11/00; B05C 13/02; G02B 1/10; G02B 5/08

(52) U.S. Cl. CPC B25B 11/002; G02B 5/08; B05C 13/02; G02B 1/10
USPC 359/839; 269/8; 118/500; 427/162

(57) ABSTRACT

An optic obscuration assembly, a system and method for working on an optical element, and the resulting optical element are described herein. In one example, the system and related components (e.g., optic obscuration assembly, positioning system, and coating system) allow the accurate placement of a very round thin metal obscuration (e.g., thin metal disk) in the center of a front surface of the optical element before a high reflective thin film coating is applied to the front surface. Once, the optical element has had the high reflective thin film coating applied thereto then the thin metal obscuration is removed to reveal a transmissive aperture.

### CLAIMING BENEFIT OF PRIOR FILED PROVISIONAL APPLICATION

This application claims the benefit of U.S. Provisional Application Ser. No. 61/770,515 filed on Feb. 28, 2013. The disclosure of which is incorporated by reference herein.

### TECHNICAL FIELD

The present invention relates to a new system, method and related components which allow the accurate placement of a very round thin metal obscuration (e.g., thin metal disk) in the center of a front surface on an optical element before a high reflective coating is applied to the front surface. Once, the optical element has had the high reflective thin film coating applied thereto then the thin metal obscuration is removed to reveal a transmissive aperture.

### BACKGROUND

In the field of optics, there are certain applications which require the use of an optical element which has a reflective coating thereon and a transmissive aperture therein. In the past, such an optical element was formed by coating an entire surface of the optical element with a high reflective thin film coating and then the reflective coating in the center of the optical element was removed by using an ion beam milling process to reveal a transmissive aperture. One way to enhance the forming of such an optical element is the subject of the present invention.

### SUMMARY

An optic obscuration assembly, a system and method for working on an optical element, and the resulting optical element have been described in the independent claims of the present application. Advantageous embodiments of the optic obscuration assembly, the system and method for working on an optical element, and the resulting optical element have been described in the dependent claims.

In one aspect, the present invention provides an optic obscuration assembly for holding an optical element. The optic obscuration assembly comprises: (a) a back cover comprising a magnet holder, where the magnet holder is configured to hold a magnet; and (2) an optical element cell, connected to the back cover, within which there is held the optical element such that a front surface of the optical element is exposed and a back surface of the optical element is located a predetermined distance from the magnet.

In another aspect, the present invention provides a system for working on an optical element. The system comprises: (1) an optic obscuration assembly which is configured to hold the optical element which does not have a reflective coating and which comprises: (a) a back cover comprising a magnet holder, where the magnet holder is configured to hold a magnet; and (b) an optical element cell, connected to the back cover, within which there is held the optical element such that a front surface of the optical element is exposed and a back surface of the optical element is located a predetermined distance from the magnet; (2) a positioning system configured to place a metal obscuration on a predetermined position (e.g., center) of the front surface of the optical element while the optical element is held in the optic obscuration assembly and the magnet holds the metal obscuration in the predetermined position (e.g., center) on the optical element; and (3) a coating system configured to deposit (e.g., via a vacuum deposition technique) a reflective coating onto at least an exposed portion of the front surface of the optical element while the optical element is held in the optic obscuration assembly and the magnet holds the metal obscuration in the predetermined position (e.g., center) on the optical element, After the reflective coating is deposited onto the optical element then the metal obscuration is removed from the front surface of the optical element and the optical element is removed from the optic obscuration assembly. The removed optical element has the reflective coating located thereon and a transmissive aperture located in the predetermined position (e.g., center) where the metal obscuration was originally placed and subsequently removed from.

In yet another aspect, the present invention provides a method for working on an optical element. The method comprises the steps of: (1) providing the optical element which does not have a reflective coating thereon; (2) providing an optic obscuration assembly which comprises: (a) a back cover comprising a magnet holder, where the magnet holder is configured to hold a magnet; and (b) an optical element cell, connected to the back cover, within which there is held the optical element such that a front surface of the optical element is exposed and a back surface of the optical element is located a predetermined distance from the magnet; (3) placing a metal obscuration on a predetermined position (e.g., center) of the front surface of the optical element while the optical element is held in the optic obscuration assembly and the magnet holds the metal obscuration in the predetermined position (e.g., center) on the optical element; (4) depositing (e.g., via a vacuum deposition technique) the reflective coating onto at least an exposed portion of the front surface of the optical element while the optical element is held in the optic obscuration assembly and the magnet holds the metal obscuration in the predetermined position (e.g., center) on the optical element; (5) removing the metal obscuration from the front surface of the optical element; and (6) removing the optical element from the optic obscuration assembly. The removed optical element has the reflective coating located thereon and a transmissive aperture located in the predetermined position (e.g., center) where the metal obscuration was originally placed and subsequently removed from.

In still yet another aspect, the present invention provides an optical element which has a reflective coating located on a front surface thereof and a non-ion milled transmissive aperture at a predetermined position (e.g., center) of the front surface, and wherein the non-ion milled transmissive aperture is surrounded by the reflective coating. The optical element can be a concave optical element, a plano (flat) optical element, or a convex optical element.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be had by reference to the following detailed description when taken in conjunction with the accompanying drawings wherein:

FIG. 1 is a basic diagram of a new system comprising an optic obscuration assembly, a positioning system, and a coating system which are configured to work on an optical element in accordance with an embodiment of the present invention;

FIGS. 2A-2D are various diagrams of an exemplary optic obscuration assembly which is configured to hold a concaved optical element in accordance with one embodiment of the present invention;

FIGS. 3A-3B are various diagrams of an exemplary optic obscuration assembly which is configured to hold a plano (flat) optical element in accordance with another embodiment of the present invention;

FIGS. 4A-4D are various diagrams illustrating an exemplary positioning system in accordance with an embodiment of the present invention;

FIGS. 5A-5D are various diagrams illustrating an exemplary coating system in accordance with an embodiment of the present invention;

FIG. 6 is a flowchart illustrating the steps of a method for working on an optical element in accordance with an embodiment of the present invention; and

FIGS. 7A-7C are perspective diagrams respectively illustrating the resulting concave optical element, the resulting plano optical element, and the resulting convex optical element in accordance with an embodiment of the present invention.

### DETAILED DESCRIPTION

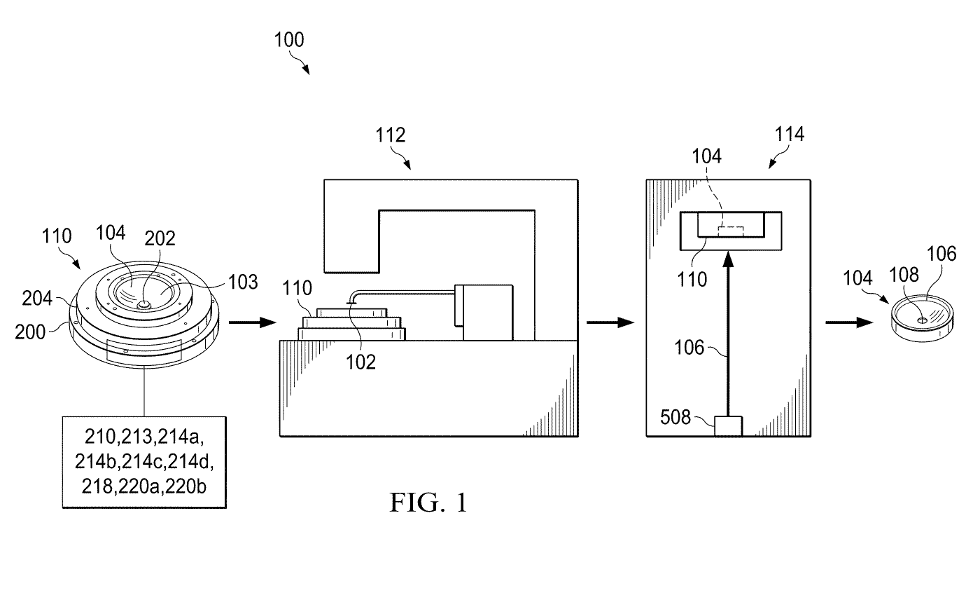

The present invention is related to a new system 100 and its associated components which allow the accurate placement of a very round thin metal obscuration 102 in the center of a front surface 103 of an optical element 104 before a high reflective coating 106 is applied to the front surface 103. Once, the optical element 104 has had the high reflective coating 106 applied thereto then the metal obscuration 102 is removed to reveal a transmissive aperture 108. The new system 100 and its associated components namely an optic obscuration assembly 110 (which holds the optical element 104), a positioning system 112 (which aligns and places the metal obscuration 102 onto the optical element 104 which is held by the optic obscuration assembly 110), and a coating system 114 (which deposits the high reflective coating 106 onto the optical element 104 which is still being held by the optic obscuration assembly 110) are all discussed in detail below with respect to FIGS. 1-7C.

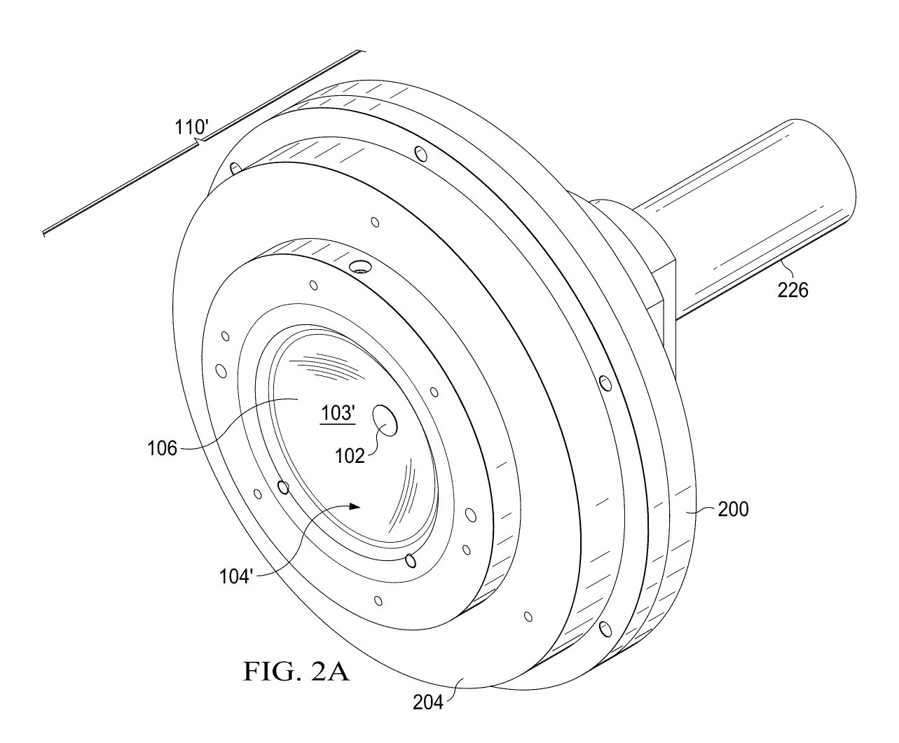

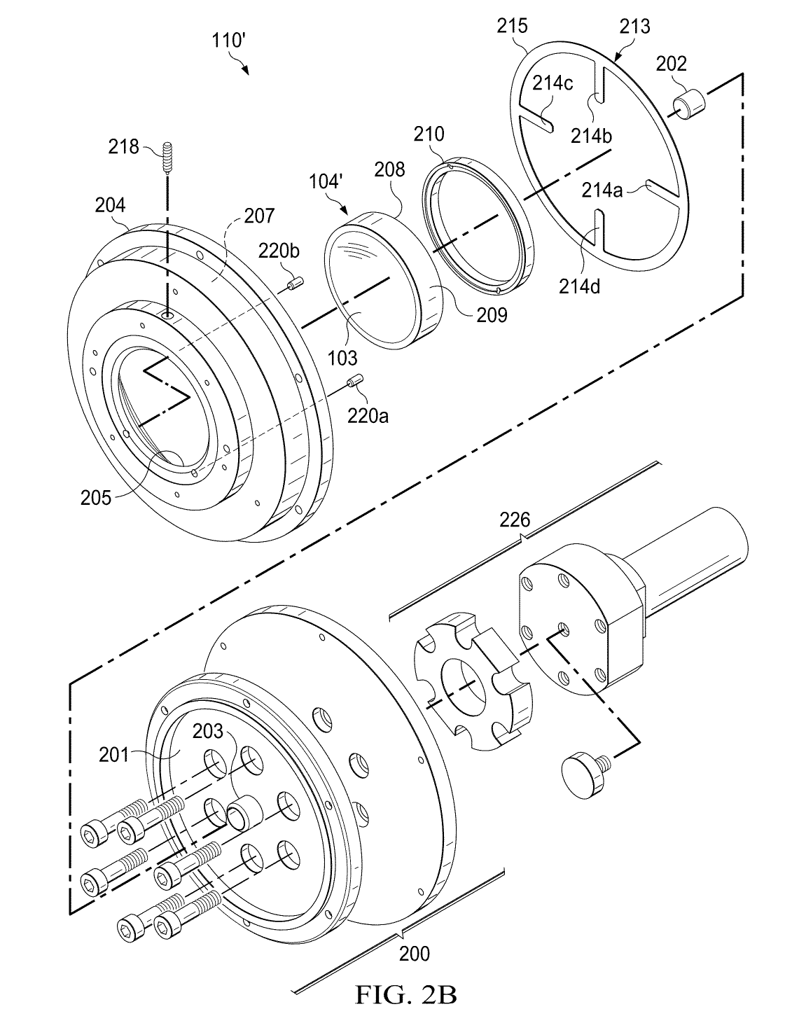

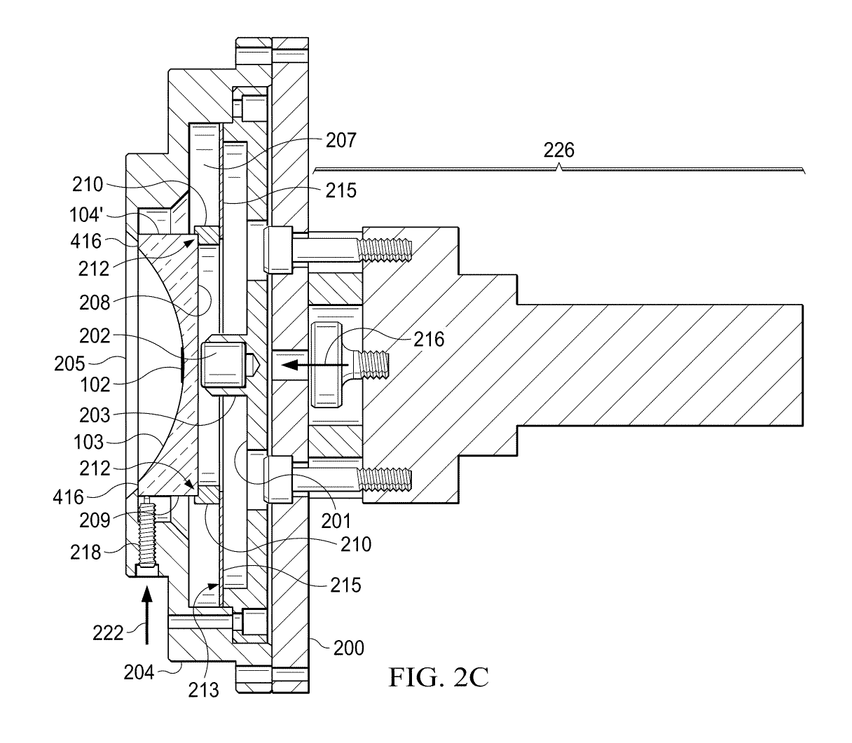

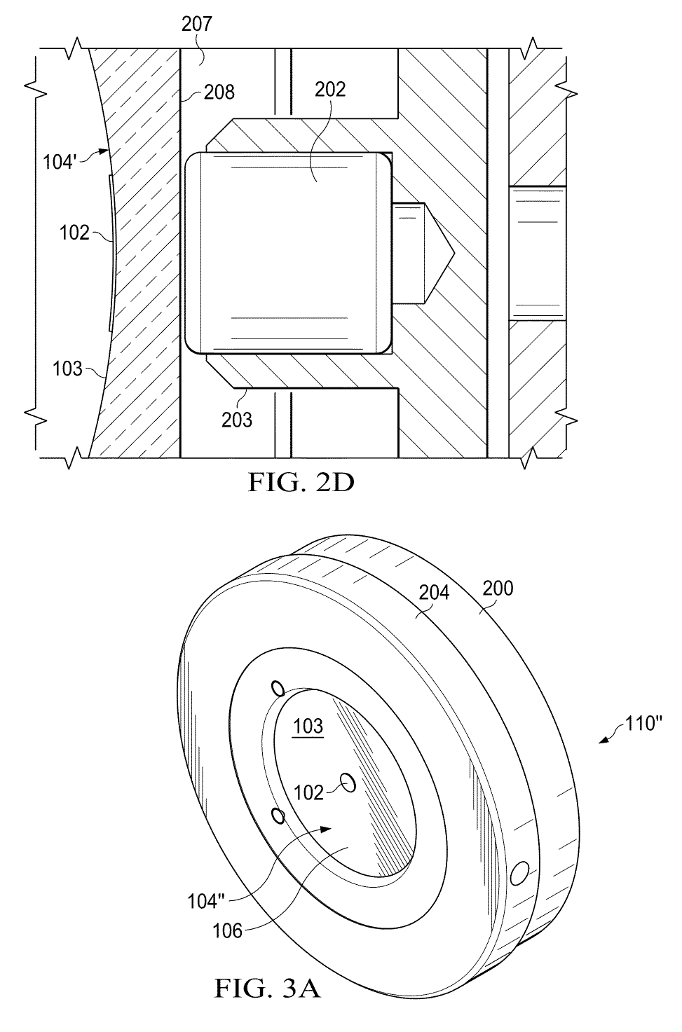

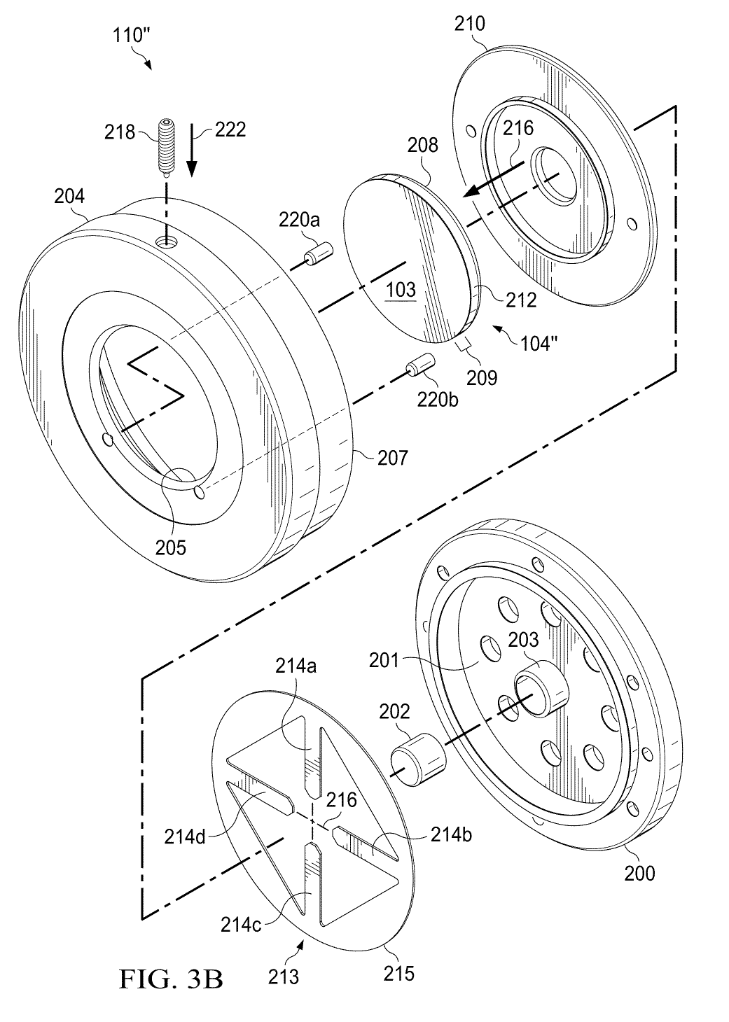

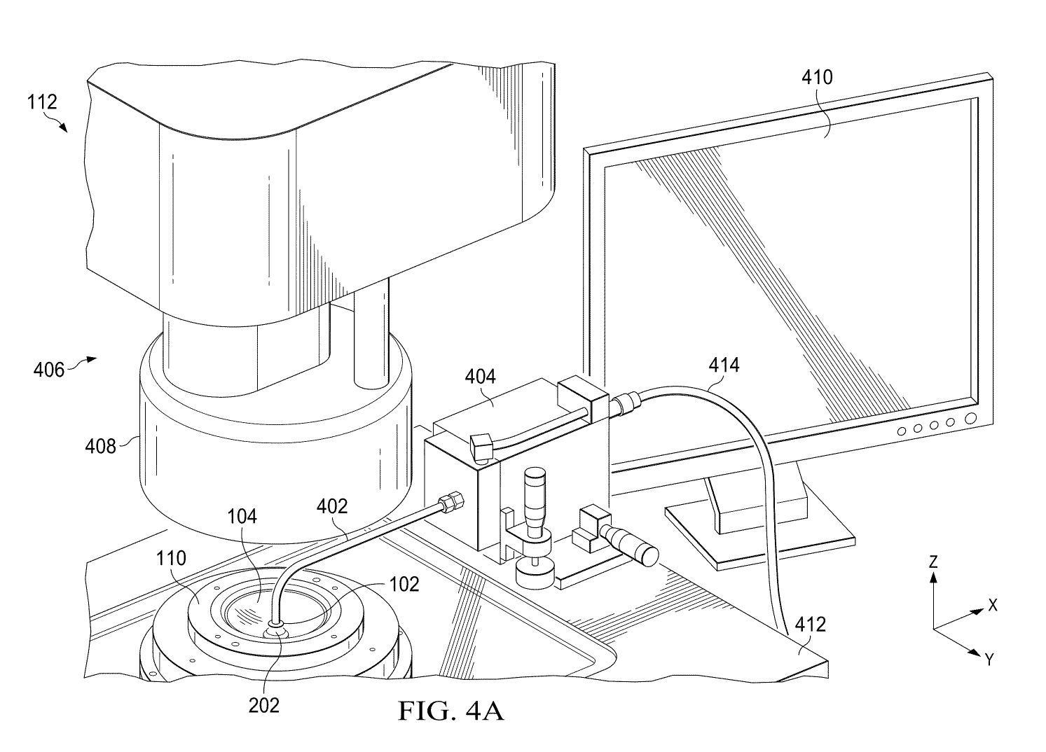

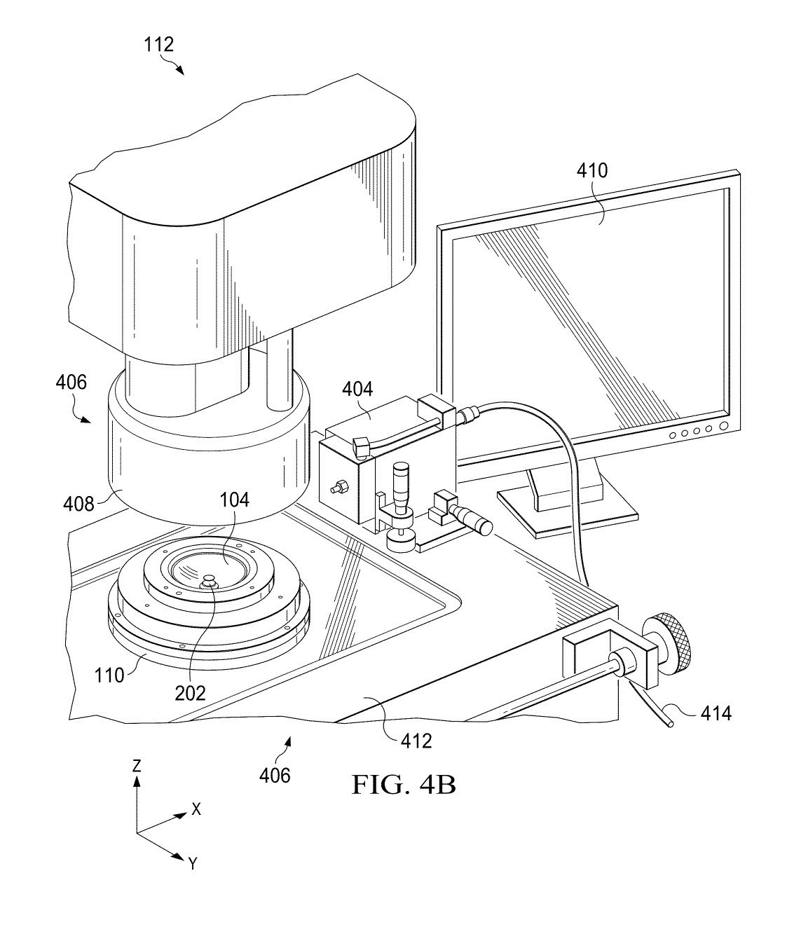

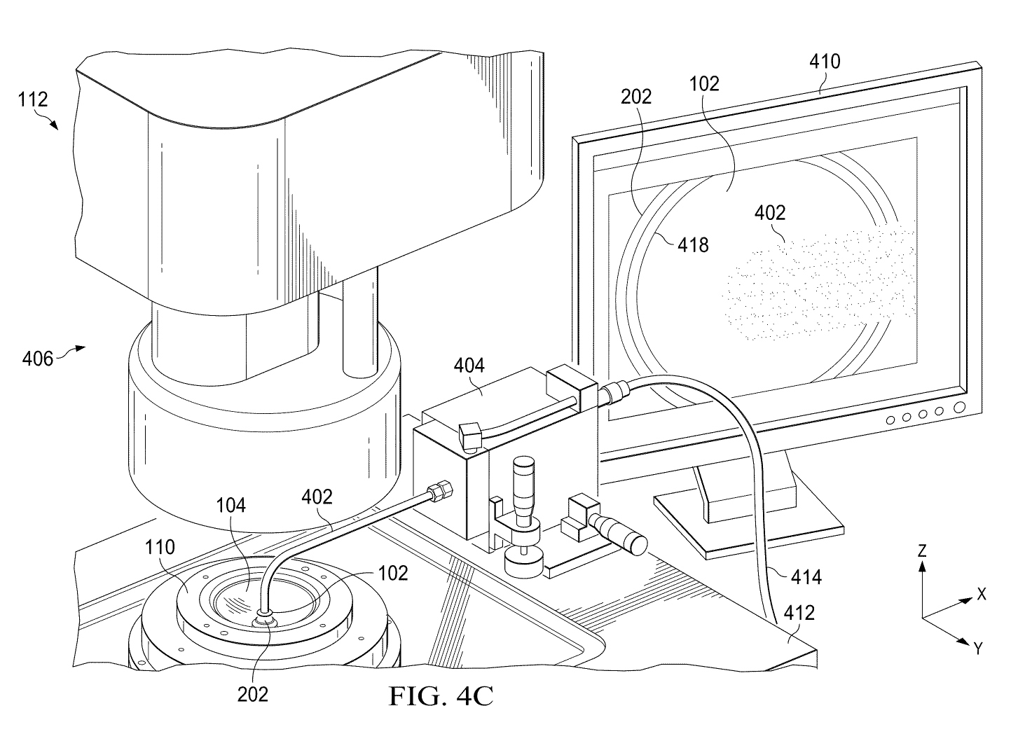

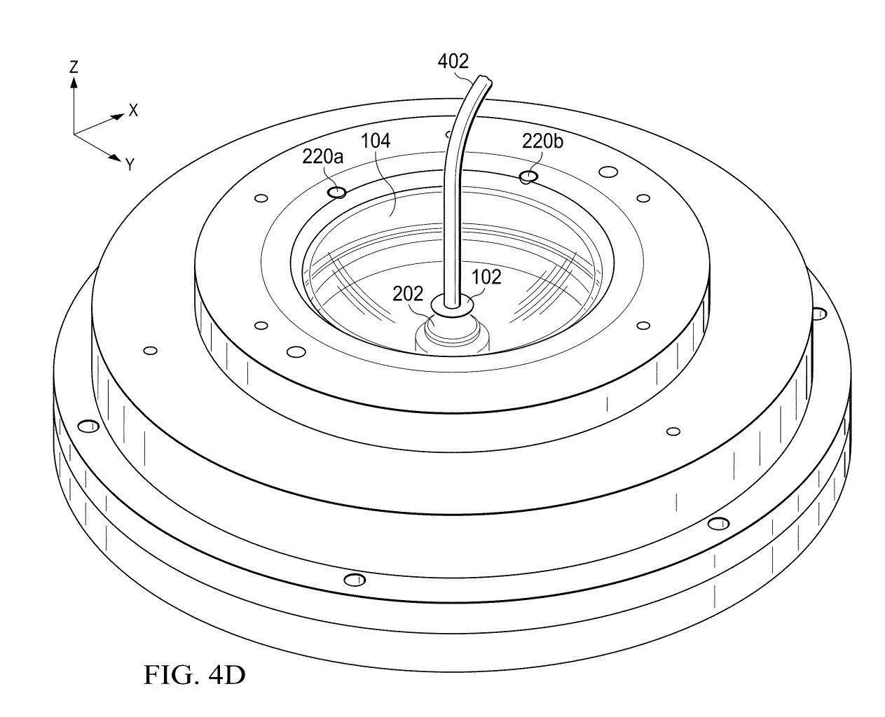

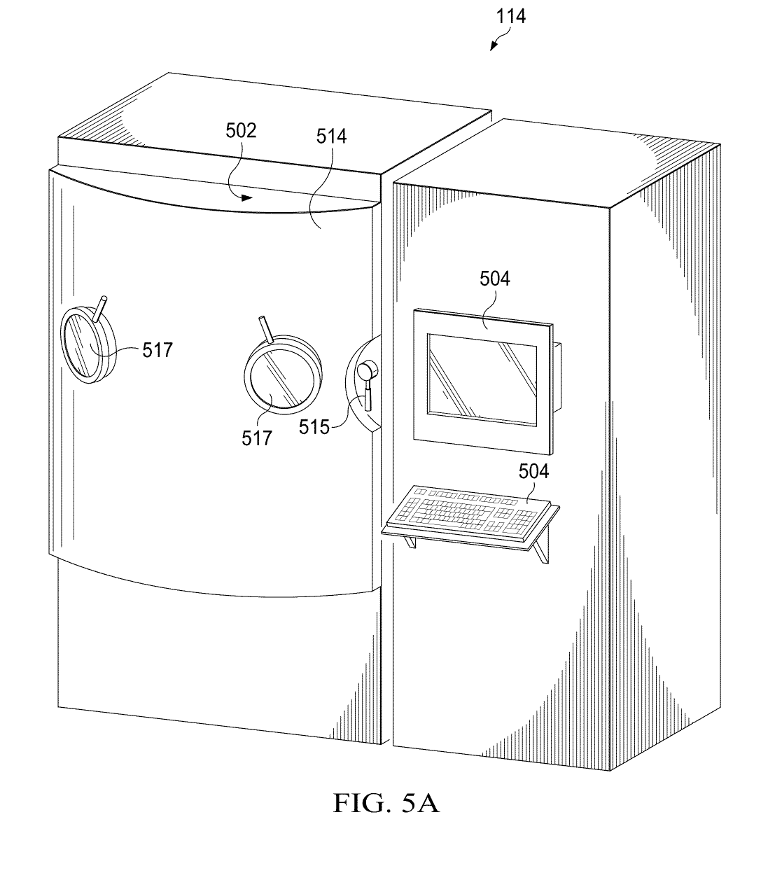

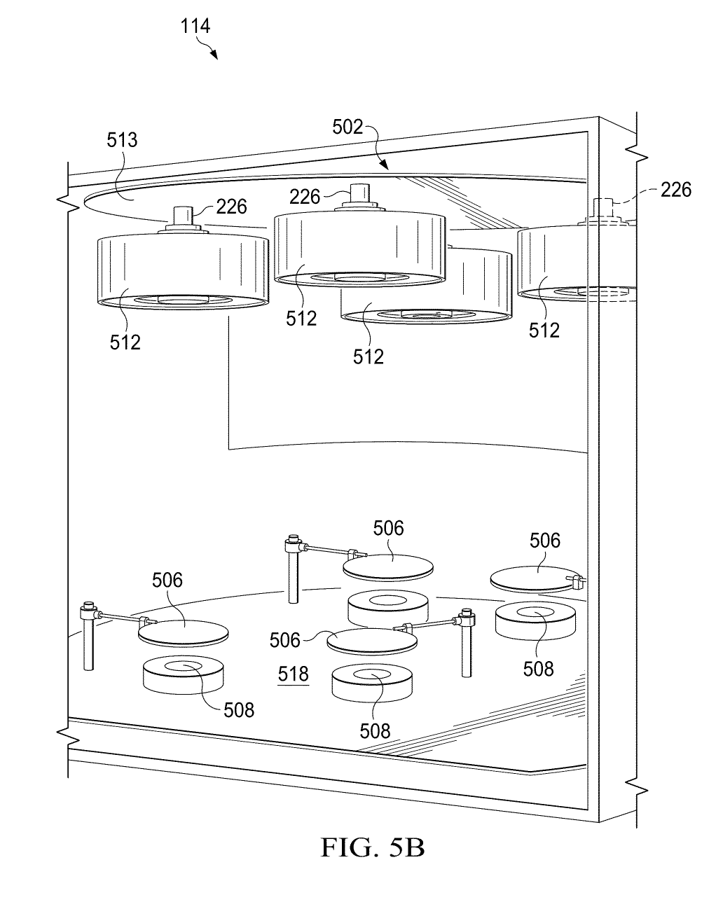

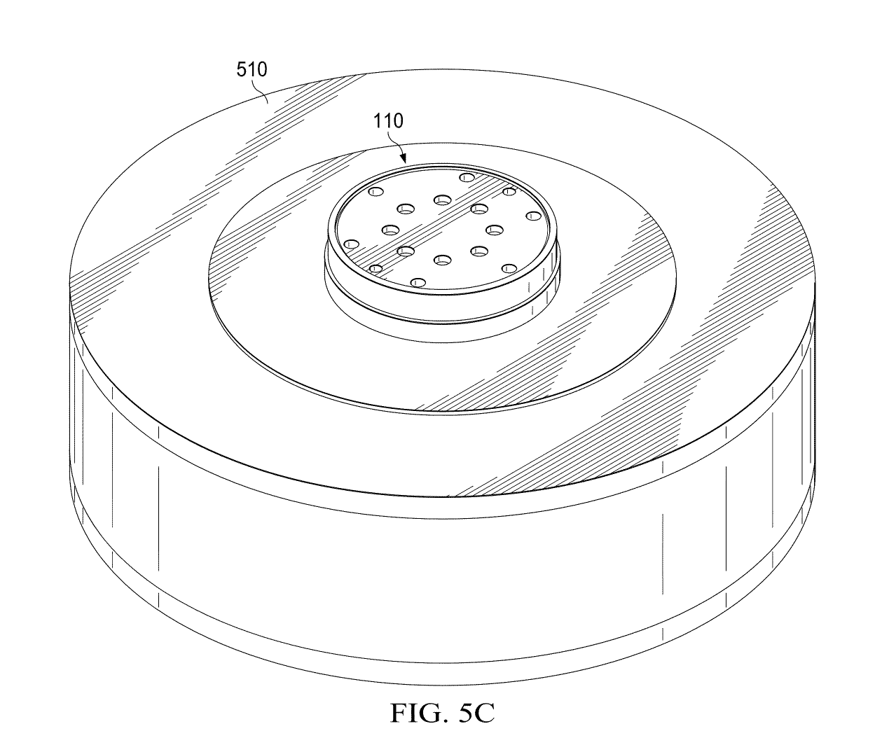

Referring to FIG. 1, there is shown a basic diagram of the new system 100 comprising the optic obscuration assembly 110, the positioning system 112, and the coating system 114 (e.g., thin film coating system 114) which are configured to work on the optical element 104 in accordance with an embodiment of the present invention. The optic obscuration assembly 110 is configured to hold the optical element 104 while the work is being performed thereon. The optical element 104 in the beginning of the work process does not have the reflective coating 106 or the metal obscuration 102 located thereon (note: two exemplary embodiments of the optic obscuration assembly 110 are discussed below with respect to FIGS. 2A-2D and 3A-3B). In the next step, the positioning system 112 is configured to place the metal obscuration 102 onto a predetermined position (e.g., the center) of a front surface 103 (exposed surface 103) of the optical element 104 while the optical element 104 is held in the optic obscuration assembly 110 and a magnet 202 which is located in the optic obscuration assembly 110 holds the metal obscuration 102 in a predetermined position on the optical element 104 (note: the positioning system 112 is described in greater detail below with respect to FIGS. 4A-4D). In the following step, the coating system 114 is configured to deposit the reflective coating 106 onto at least an exposed portion of the front surface 103 of the optical element 104 while the optical element 104 is held in the optic obscuration assembly 110 and the magnet 202 holds the metal obscuration 102 in the predetermined position on the optical element 104 (note: an exemplary thin film vacuum deposition coating system 114 is described in greater detail below with respect to FIGS. 5A-5D). Once, the reflective coating 106 is deposited onto the optical element 104 the metal obscuration 102 is removed from the front surface 103 of the optical element 104 and then the optical element 104 is removed from the optic obscuration assembly 110. Alternatively, once the reflective coating 106 is deposited onto the optical element 104 the optical element 104 can be removed from the optic obscuration assembly 110 and then the metal obscuration 102 is removed from the front surface 103 of the optical element 104. In any case, the resulting optical element 104 has the reflective coating 106 located thereon and a transmissive aperture 108 located in the predetermined position (e.g., center) where the metal obscuration 102 was originally placed and subsequently removed from (note: three exemplary resulting optical elements 104 are described in greater detail below with respect to FIGS. 7A-7C).

The optic obscuration assembly 110 comprises: (1) a back cover 200 which has a magnet holder 203 that is configured to hold or otherwise support and secure the magnet 202; (2) an optical element cell 204 which is connected to the back cover 200 and within which there is held the optical element 104 (without the reflective coating 106) such that the front surface 103 of the optical element 104 is exposed and a back surface 208 of the optical element 104 is located a predetermined distance from the magnet 202; (3) a spring flexure ring 210 (located between the back cover 200 and the optical element cell 204) configured to support an outer perimeter 212 of the back surface 208 of the optical element 104; (4) a spring flexure device 213 which includes multiple spring flexures 214a, 214b, 214c and 214d (four shown) each having a first end attached to a support ring 215 (or the back cover 200, or the optical element cell 204) and a second end attached to or at least in contact with the spring flexure ring 210, where the multiple spring flexures 214a, 214b, 214c and 214d are configured to apply an axial force 216 through the spring flexure ring 210 to the optical element 104; (5) a spring plunger 218 which has a first end attached to the optical cell element 204 and a second end that contacts an outer diameter 209 of the optical element 104; and (6) two support pins 220a and 220b which are secured to the optical cell element 204 and configured to contact different parts of the outer diameter 209 of the optical element 104, where the spring plunger 218 is configured to apply a radial force 222 to the optical element 104. Two exemplary embodiments of the optic obscuration assembly 110 are discussed in more detail below with respect to FIGS. 2A-2D and 3A-3B.

Referring to FIGS. 2A-2D, there are various diagrams of an exemplary optic obscuration assembly 110′ which is configured to hold a concave optical element 104′ in accordance with one embodiment of the present invention. FIG. 2A shows the assembled optic obscuration assembly 110′ (coating fixture 110′) where the back cover 200 is attached to the optical element cell 204 and within the optical element cell 204 there is held the concave optical element 104′. The back cover 200 is also shown attached to a coating chamber spindle 226 which is part of the coating system 114 and functions to allow the optic obscuration assembly 110′ and in particular the concave optical element 104′ held therein to be tilted so the front surface 103′ of the concave optical element 104′ is normal to a coating source 508 (e.g., plasma assisted deposition source 508) when the coating source 508 emits the high reflective coating 106 onto the concave optical element 104′ (see discussion below with respect to FIGS. 5A-5D). In this particular drawing, the concave optical element 104′ is shown as having both the metal obscuration 102 and reflective coating 106 applied thereto but in the beginning of the process it should be appreciated that neither the metal obscuration 102 or the reflective coating 106 would be located on the optical element 104′.

FIGS. 2B, 2C and 2D are respectively an exploded view, a cross-sectional side view, and a partial cross-sectional side view of the optic obscuration assembly 110′ which illustrate the various components located within the back cover 200 and the optical element cell 204. The optic obscuration assembly 110′ comprises the back cover 200 which has the magnet holder 203 that is configured to hold or otherwise support and secure the magnet 202 (note: the back cover 200/magnet holder 203 in this example is secured to the coating chamber spindle 226 with six fasteners). In this example, the magnet holder 203 protrudes from the magnet holder 200 but any type of securing means could be used to secure the magnet 202. The optical element cell 204 has a front opening 205 and a back opening 207. The concave optical element 104′ (without the reflective coating 106 or the metal obscuration 102) is placed within the optical element cell 204 through the back opening 207 and is held therein by the front opening 205 which has a slightly smaller diameter than the outer diameter of the concave optical element 104′. In particular, the optical element cell 204 holds the concave optical element 104′ such that the front surface 103′ of the concave optical element 104′ is exposed and a back surface 208 of the concave optical element 104′ is located a predetermined distance from the magnet 202. In this example, the nominal gap between the optical element 104′ and the magnet 202 was 0.010″. Then, the optical element cell 204 is connected by any suitable type of fasteners (not shown) to the back cover 200.

The optic obscuration assembly 110′ also comprises a spring flexure ring 210 and a spring flexure device 213 (which includes multiple spring flexures 214a, 214b, 214c and 214d (four shown) extending outward from a support ring 215) both of which are located between the back cover 200 and the optical element cell 204. In this example, the spring flexures 214a, 214b, 214c and 214d each have an inner end attached to the support ring 215 and an outer end attached to or at least in contact with the spring flexure ring 210. Alternatively, the spring flexures 214a, 214b, 214c and 214d can each have an inner end attached to the magnet holder 203 (or back cover 200) and an outer end attached to or at least in contact with the spring flexure ring 210. As shown, the spring flexures 214a, 214b, 214c and 214d can be located at 90 degree increments around the both the support ring 215 and the spring flexure ring 210. The spring flexure ring 210 is configured to support an outer perimeter 212 of the back surface 208 of the concave optical element 104′. The spring flexures 214a, 214b, 214c and 214d are configured to apply an axial force 216 through the spring flexure ring 210 to the concave optical element 104′ such that the concave optical element 104′ is pushed towards the front opening 205 of the optical cell element 204. The advantage of this set-up and in particular the application of the spring-loaded axial force 216 to the concaved optical element 104′ is discussed in detail below.

The optic obscuration assembly 110′ further comprises a spring plunger 218 and two support pins 220a and 220b which are located within the optical element cell 204. The spring plunger 218 which has a first end attached to the optical cell element 204 and a second end that contacts an outer diameter 209 of the concaved optical element 104′. The spring plunger 218 is configured to apply a radial force 222 to the concaved optical element 104′ such that the concaved optical element 104′ is pushed towards a center line of the front opening 205 of the optical cell element 204. The support pins 220a and 220b are secured to the optical cell element 204 and configured to contact the outer diameter 209 of the concaved optical element 104′ when the spring plunger 218 applies the radial force 222 to the concaved optical element 104′. In this example, the support pins 220a and 220b are positioned to contact parts of the outer diameter 209 of the concaved optical element 104′ which are opposite of where the spring plunger 218 contacts the outer diameter 209 of the concaved optical element 104′. The advantage of having the spring flexure ring 210/spring flexures 214a, 214b, 214c and 214d along with the spring plunger 218 applying both the axial force 216 and the radial force 222 to the concaved optical element 104′ is that the optic obscuration assembly 110′ (namely the back cover 200 and optical cell element 204) is allowed to grow and shrink with temperature changes during the coating process without inducing strain into the concave optical element 104′ due to a thermal coefficient of expansion mismatch between the concave optical element 104′ and the optic obscuration assembly 110's components.

Referring to FIGS. 3A-3B, there are various diagrams of an exemplary optic obscuration assembly 110″ which is configured to hold a plano (flat) optical element 104″ in accordance with another embodiment of the present invention. FIG. 3A shows the assembled optic obscuration assembly 110″ (coating fixture 110″) where the back cover 200 is attached to the optical element cell 204 and within the optical element cell 204 there is held the plano optical element 104″. In this embodiment, the back cover 200 does not need to be attached to a coating chamber spindle 226 as in the previous embodiment since there is no need to change the orientation of the optical element 104″ when the high reflective coating 106 is being applied to the plano optical element 104″. In this particular drawing, the plano optical element 104″ is shown as having both the metal obscuration 102 and reflective coating 106 applied thereto but in the beginning of the process it should be appreciated that neither the metal obscuration 102 or the reflective coating 106 would be located on the optical element's surface 103.

FIG. 3B is an exploded view of the disassembled optic obscuration assembly 110″ which illustrates the various components located within the back cover 200 and the optical element cell 204. The optic obscuration assembly 110″ comprises the back cover 200 which has an inner surface 201 on which the magnet 202 is placed and secured by a magnet holder 203. In this example, the magnet holder 203 protrudes from the back cover's inner surface 201 but any type of securing means could be used to secure the magnet 202. The optical element cell 204 has a front opening 205 and a back opening 207. The plano optical element 104″ (without the reflective coating 106 or the metal obscuration 102) is placed within the optical element cell 204 through the back opening 207 and is held therein by the front opening 205 which has slightly smaller diameter than the outer diameter of the plano optical element 104″. In particular, the optical element cell 204 holds the plano optical element 104″ such that the front surface 103 of the plano optical element 104″ is exposed and a back surface 208 of the plano optical element 104″ is located a predetermined distance from the magnet 202. Then, the optical element cell 204 is connected by any suitable type of fasteners (not shown) to the back cover 200.

The optic obscuration assembly 110″ also comprises a spring flexure ring 210 and a spring flexure device 213 (which includes multiple spring flexures 214a, 214b, 214c and 214d (four shown) extending outward from a support ring 215) both of which are located between the back cover 200 and the optical element cell 204. In this example, the spring flexures 214a, 214b, 214c and 214d each have an inner end attached to the support ring 215 and an outer end in contact with the spring flexure ring 210. Alternatively, the spring flexures 214a, 214b, 214c and 214d can each have an inner end in contact with the back cover 200 and an outer end in contact with the spring flexure ring 210. As shown, the spring flexures 214a, 214b, 214c and 214d can be located at 90 degree increments around the both the support ring 215 and the spring flexure ring 210. The spring flexure ring 210 is configured to support an outer perimeter 212 of the back surface 208 of the plano optical element 104″. Plus, the spring flexures 214a, 214b, 214c and 214d are configured to apply an axial force 216 through the spring flexure ring 210 to the plano optical element 104″ such that the plano optical element 104″ is pushed towards the front opening 205 of the optical cell element 204. The advantage of this set-up and in particular the application of the spring-loaded axial force 216 to the plano optical element 104″ is discussed in detail below.

The optic obscuration assembly 110″ further comprises a spring plunger 218 and two support pins 220a and 220b which are located within the optical element cell 204. The spring plunger 218 which has a first end attached to the optical cell element 204 and a second end that contacts an outer diameter 209 of the plano optical element 104″. The spring plunger 218 is configured to apply a radial force 222 to the plano optical element 104″ such that the plano optical element 104″ is pushed towards a center line of the front opening 205 of the optical cell element 204. The support pins 220a and 220b are secured to the optical cell element 204 and configured to contact the outer diameter 209 of the plano optical element 104″ when the spring plunger 218 applies the radial force 222 to the plano optical element 104″. In this example, the support pins 220a and 220b are positioned to contact parts of the outer diameter 209 of the plano optical element 104″ which are opposite of where the spring plunger 218 contacts the outer diameter 209 of the plano optical element 104″. The advantage of having the spring flexure ring 210/spring flexures 214a, 214b, 214c and 214d along with the spring plunger 218 applying both the axial force 216 and the radial force 222 to the plano optical element 104″ is that the optic obscuration assembly 110′ (namely the back cover 200 and optical cell element 204) is allowed to grow and shrink with temperature changes during the coating process without inducing strain into the plano optical element 104″due to a thermal coefficient of expansion mismatch between the plano optical element 104″ and the optic obscuration assembly 110″s components.

Referring to FIGS. 4A-4D, there are various diagrams illustrating an exemplary positioning system 112 in accordance with an embodiment of the present invention. The positioning system 112 is configured to place the metal obscuration 102 in a predetermined position (e.g., the center) on the optical element 104 which is being held by the optic obscuration assembly 110. The positioning system 112 includes the following components: (1) a vacuum wand 402; (2) a x/y/z micrometer driven stage 404 which can move in the x-direction, y-direction and z-direction; (3) a video inspection instrument 406 (e.g., RAM Sprint 200) including a video equipment 408, a monitor 410, and an x/y stage 412 which can move in the x-direction and y-direction. A detailed discussion is provided next to explain one way how the positioning system 112 can be operated to place the metal obscuration 102 onto a predetermined location (e.g., the center) of the optical element 104 which is being held by the optic obscuration assembly 110.

In operation, the metal obscuration 102 is placed on the optical element 104 using the custom vacuum wand 402 that is mounted onto the x/y/z micrometer driven stage 404 (see FIG. 4A). In this example, the metal obscuration 102 was a 0.002″ thick disk of 410 stainless steel which was created by using a photo etching process. The vacuum wand 402 is attached to a portable vacuum pump 414 that generates a minimum of 20 inches of mercury. The video inspection instrument 406 (e.g., RAM Sprint 200) is used to determine the center of the optical element 104 (see FIG. 4B). To accomplish this, the video inspection system 406 implements software to measure the diameter of the optic element 104 at an intersection of the bevel 416 (i.e., flat portion) and optical surface 103 (see FIG. 2C—which shows the bevel 416/optical surface 103 intersection). This is a very accurate way to determine the optical axis (center) of the optical surface 103 and once this is done the video inspection instrument 406 is re-zeroed at the center of the measured diameter, making 0,0 (x=0, y=0) on the video inspection instrument 406 the optical axis reference. Thereafter, a circle 418, whose diameter can be easily changed, is then constructed at the 0,0 location using the video inspection instrument's software (see FIG. 4C—the monitor 410 displays the circle 418 where it should be appreciated that the circle 418 is not physically drawn on the optical element 104). The circle 418 is the target for alignment and placement of the metal obscuration 102 onto the optical element 104 (e.g., lens 104). Typically, the circle 418 is the same size as the metal obscuration 102.

However, prior to finding the optical axis and constructing the circle 418, the x/y/z micrometer driven stage 404 is bolted to the video inspection instrument's x/y stage 412, and the vacuum wand 402 is removed such that the video inspection instrument's video equipment 408 has an unobstructed view of the optic element 104 for the centering procedure (see FIG. 4B). After the 0,0 location has been established for the optical element 104, the vacuum wand 402 is carefully installed and the metal obscuration 102 is attached thereto using, for instance, a pair of tweezers (see FIG. 4C). The centering of the metal obscuration 102 on the vacuum wand 402 is not critical to the obscuration placement process. Then, using the video inspection instrument 406, the vacuum wand 402 is moved so the metal obscuration 102 is driven to the target circle 418 on the optical element 104 using the x/y/z micrometer driven stage 404.

Once the metal obscuration 102 is centered in the x and y locations on the target circle 418, the metal obscuration 102 is slowly driven down in the z-direction by the x/y/z micrometer driven stage 404 to the front surface 103 of the optical element 104 using the z motion and making corrections to the x-direction and the y-direction as necessary during the translation. It was found that the most accurate placement could be obtained by driving the metal obscuration 102 down until it actually touched the front surface 103 of the optical element 104 before removing the vacuum from the vacuum wand 402. If the metal obscuration 102 was not in intimate contact with the optic element 104, then it would “jump” or “skid” slightly in the x or y direction when the vacuum was removed from the vacuum wand 402. Once, the metal obscuration 102 was in place, it would be measured for centration accuracy using the video inspection instrument 406. In practice, the metal obscuration 102 has been centered to within 5 microns.

The aforementioned positioning process and the placement of the metal obscuration 102 onto the optical element 104 would be the same for the concave optical element 104′ and the plano optical element 104″ except for one difference as discussed next. In the case of the plano optical element 104″, the reference surface which is used to determine the optical axis of the plano optical element 104″ is a precision diameter of the optic obscuration assembly 110″ (coating fixture 110″) which is based on/toleranced to the two support pins 220a and 220b and which in turn the outside diameter of the plano optical element 104″ is referenced to this precision diameter in order to determine the center (0,0 location) of the plano optical element 104″ (see FIG. 3B). Therefore, the centration accuracy of the metal obscuration 102 will not be as precise on the plano optical element 104″ as it is for the concave optical element 104″ due to this tolerance stack-up. It should be appreciated that a similar obscuration placement assembly and procedure can be used with a convex optical element 104′″ but in this case the thin metal obscuration 102 should have a radius of curvature that matches the convex surface 103 of the convex optical element 104′″ (see FIG. 7C).

Referring to FIGS. 5A-5D, there are various diagrams illustrating an exemplary coating system 114 in accordance with an embodiment of the present invention. The coating system 114 is configured to deposit the reflective coating 106 onto at least an exposed portion of the front surface 103 of the optical element 104 while the optical element 104 is held in the optic obscuration assembly 110 and the magnet 202 holds the metal obscuration 102 in the predetermined position (e.g., center) on the optical element 104 (see FIG. 1). The coating system 114 includes the following components: (1) a coating chamber 502; (2) a computer 504 (process control system 504) for controlling and monitoring the various components such as paddles 506 and crucible/e-beam apparatus 508 within the coating chamber 502; (3) one or more coating fixtures 510 within each of which there is secured an optic obscuration assembly 110 and optical element 104; and (4) one or more hanging fixtures 512 which are secured to a top surface 513 of the interior of the coating chamber 502 and each of which are configured to receive and hold the coating fixture 510 which in turn holds the optic obscuration assembly 110 and the optical element 104. It should be appreciated that the crucible/e-beam apparatus 508 basically includes a storage unit (crucible) for the coating material 106 and the e-beam is the film coating source which vaporizes the coating material 106 within the storage unit and the vaporized coating material 106 is directed towards the optical element 104. It should also be appreciated that multiple types of coating systems can be used in the coating process, for instance one coating chamber can deposit a coating material (e.g., aluminum) via e-beam and then another coating chamber can deposit another coating material (e.g., DUVHR coating) over the previously deposited coating material (e.g., aluminum).

In the illustrated example, FIG. 5A shows the exterior of the coating chamber 502 which includes a door 514 (with a handle 515 and a pair of windows 517) and on which there is secured the computer 504. FIG. 5B shows the interior of the coating chamber 114 where the crucible/e-beam apparatuses 508 are located under the movable paddles 506. The movable paddles 506 and crucible/e-beam apparatuses 508 are located on a bottom surface 518 of the coating chamber 114. The coating chamber 114 also has the hanging fixtures 512 mounted on the top surface 513 therein where each hanging fixture 512 has secured therein the coating fixture 510 which in turn holds with the respective optic obscuration assembly 110 and optical element 104. FIG. 5C shows a top view of the optic obscuration assembly 110 (in this particular example the plano optic obscuration assembly 110″) located within the coating fixture 510 where the optical element 104 (in this particular example the plano optical element 104″) cannot be seen since it would be located on the other side of the optic obscuration assembly 110. FIG. 5D shows the hanging fixture 512 (secured to the top surface 513 of the coating chamber 104) within which is secured the coating fixture 510 and the optic obscuration assembly 110 (in this particular example the optic obscuration assembly 110) which is holding the optical element 104 (in this particular example the concave optical element 104′) which has the metal obscuration 102 attached thereto (see also FIG. 5B). A detailed discussion is provided next to explain one way how the coating system 114 can be operated to deposit (e.g., spray) the reflective coating 106 onto at least an exposed portion of the front surface 103 of the optical element 104 while the optical element 104 is held in the optic obscuration assembly 110 and the magnet 202 holds the metal obscuration 102 in the predetermined position (e.g., center) on the optical element 104.

In operation, the metal obscuration 102 is held in place using the magnet 202 (e.g., nickel plated neodymium magnet 202) (see FIG. 2D). The magnetic force applied through the optical element 104 is strong enough to keep the metal obscuration 102 from moving during the handling and the subsequent coating process. During the coating process, the optical element 104 and entire optic obscuration assembly 110 is rotated about the axis of the coating chamber spindle 226 (if used) while it also being rotated on a larger planetary motion. For instance, the concaved optical element 104′ and the optic obscuration assembly 110′ are rotated as described here but it should be appreciated that the coating chamber spindle 226 can also be tilted such that the concave surface 103′ of the optical element 104′ is normal to the emitting source (e-beam) of the coating material 106. Furthermore, the plano optical element 104″ and the optic obscuration assembly 110″ could if desired be rotated in the same manner by utilizing a support fixture that is similar to the coating chamber fixturing as shown in FIGS. 5B, C and D. In any case, during the coating process, the spring flexures 214a, 214b, 214c and 214d apply the axial force 216 through the spring flexure ring 210 to keep the optic element 104 secured axially, while the spring plunger 218 applies the radial force 222 to the optical element 104 which is banked up against two support pins 220a and 220b (see FIGS. 2B-2D). In one example, the first coating 106 applied to the optic element 104 was an aluminum coating which was done at room temperature, followed by a multilayered enhanced deep ultra violet (DUV) high reflective coating 106 which was applied at 120° C. The spring flexures 214a, 214b, 214c and 214d and the spring plunger 218 allow the optic obscuration assembly 110 (which can be made of metal) to grow and shrink with temperature changes without inducing strain into the optical element 104. Even though there is a large difference in the coefficient of thermal expansions (CTEs) between the optic obscuration assembly 110 and the optical element 104. The metal obscuration 102 position is not effected by temperature changes from the coating process since the metal obscuration 102 is not constrained and therefore grows and shrinks relative to the optical element 104 without de-centering.

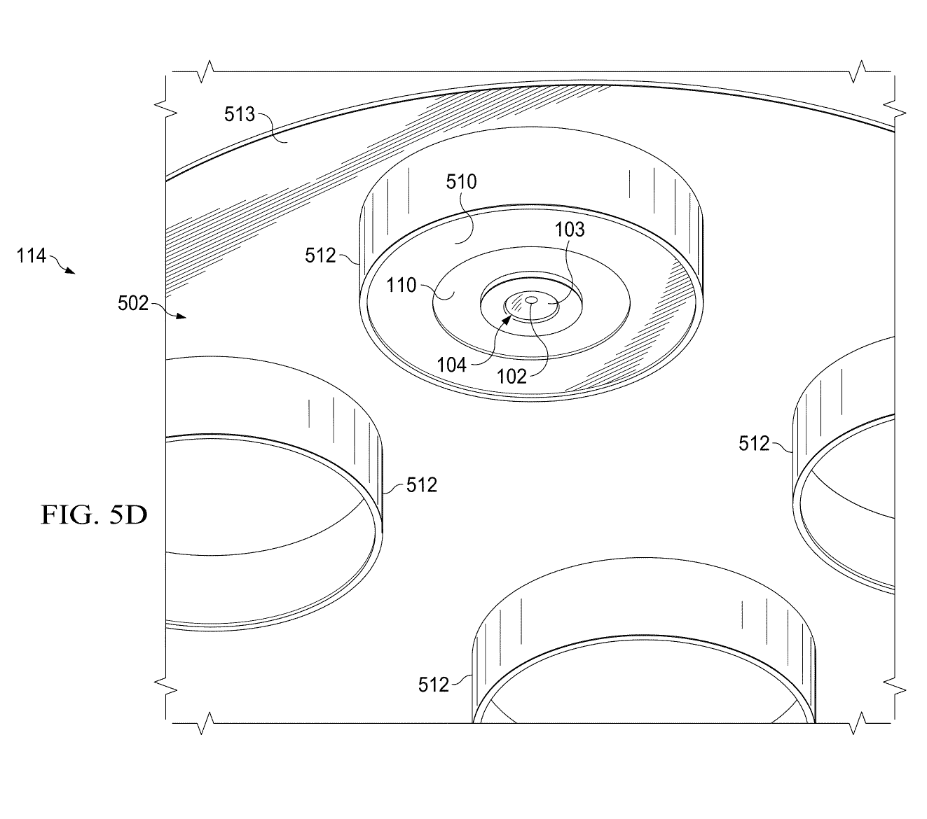

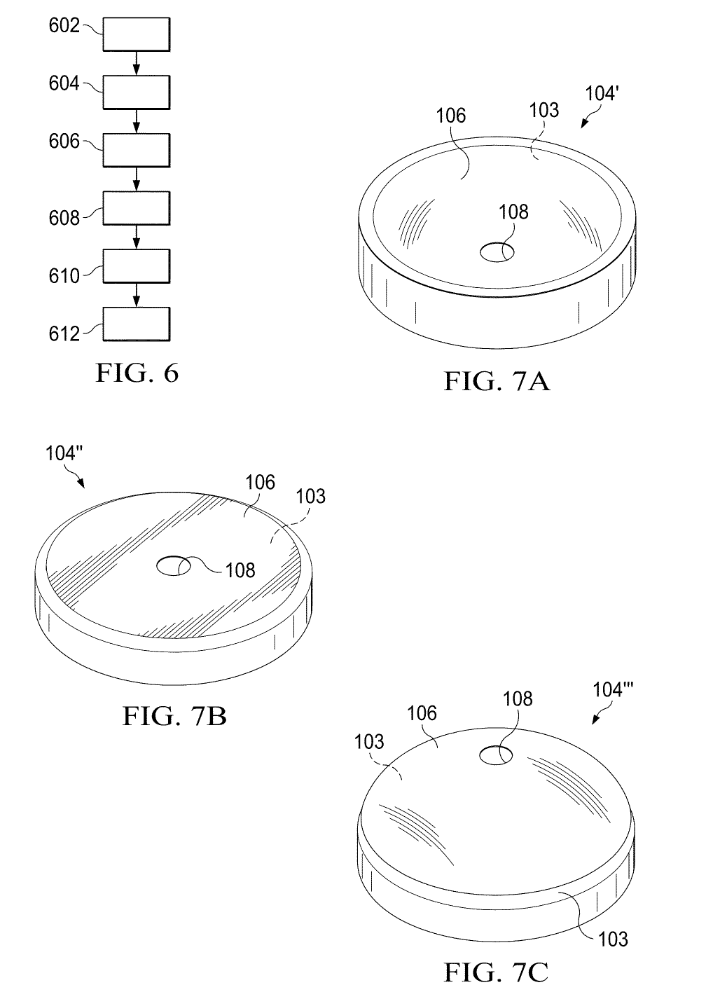

Referring to FIG. 6, there is a flowchart illustrating the steps of a method 600 for working on an optical element 104 in accordance with an embodiment of the present invention. At step 602, the optical element 104 is provided which does not have a reflective coating 106 thereon. At step 604, the optic obscuration assembly 110 is provided which is configured for holding the optical element 104. As described above, the optic obscuration assembly 110 comprises: (a) a back cover 200 which has a magnet holder 203 that is configured to hold or otherwise support and secure the magnet 202; and (b) the optical element cell 204, connected to the back cover 200, within which there is held the optical element 104 such that the front surface 103 of the optical element 104 is exposed and the back surface 208 of the optical element 104 is located a predetermined distance from the magnet 202 (see discussion related to FIGS. 2A-2D and 3A-3B). At step 606, the metal obscuration 102 is placed by the positioning system 112 on a predetermined position (e.g., center) of the front surface 103 of the optical element 104 while the optical element 104 is held in the optic obscuration assembly 110 and the magnet 202 holds the metal obscuration 102 in the predetermined position (e.g., center) on the optical element 104 (see discussion related to FIGS. 4A-4D). At step 608, the reflective coating 106 is deposited by the coating system 114 onto at least an exposed portion of the front surface 103 of the optical element 104 while the optical element 104 is held in the optic obscuration assembly 110 and the magnet 202 holds the metal obscuration 102 in the predetermined position (e.g., center) on the optical element 104 (see also discussion related to FIGS. 5A-5D). At step 610, the metal obscuration 102 is removed from the front surface 103 of the optical element 104. At step 612, the optical element 104 is removed from the optic obscuration assembly 110 (note: if desired step 610 can be performed after step 612). The removed optical element 104 has the reflective coating 106 located thereon and the transmissive aperture 108 located in the predetermined position (e.g., center) where the metal obscuration 102 was originally placed and subsequently removed from.

Referring to FIGS. 7A-7C, there are perspective diagrams respectively illustrating the resulting concave optical element 104′, the resulting plano optical element 104″ and the resulting convex optical element 104′″ in accordance with an embodiment of the present invention. As shown in FIG. 7A, the concave optical element 104′ has the reflective coating 106 located on the front surface 103 thereof and a non-milled transmissive aperture 108 which is surrounded by the reflective coating 106 and is located at a predetermined position (e.g., center) of the front surface 103. In FIG. 7B, the plano optical element 104″ has the reflective coating 106 located on the front surface 103 thereof and a non-milled transmissive aperture 108 which is surrounded by the reflective coating 106 and is located at a predetermined position (e.g., center) of the front surface 103. In FIG. 7C, the convex optical element 104′″ has the reflective coating 106 located on the front surface 103 thereof and a non-milled transmissive aperture 108 which is surrounded by the reflective coating 106 and is located at a predetermined position (e.g., center) of the front surface 103. The convex optical element 104′″ would have been held by an optic obscuration assembly 110 that closely resembles the aforementioned optic obscuration assembly 110′.

From the foregoing, one skilled in the art will appreciate from the disclosure herein that the present invention relates to the new system 100 and its associated components 110, 112 and 114 which allow the accurate placement of a very round thin metal obscuration 102 onto the center of the optical element's front surface 103 of the optical element 104 before the high reflective coating 106 is applied to the front surface 103. Once, the optical element 104 has had the high reflective coating 106 applied thereto then the metal obscuration 102 is removed to reveal a transmissive aperture 108. The present invention is a marked-improvement over the prior art where an entire surface of the optical element was coated with a high reflective thin film and then the coating in the center of the optical element was removed by using an ion beam milling process to reveal a transmissive aperture. The technical advantages of the new system 100 and method 600 over the prior art's ion milling process are as follows:
The new system 100 and method 600 form a more accurate diameter of the transmissive aperture 108.
The new system 100 and method 600 is able to more accurately center the transmissive aperture 108 relative to the optical axis of the optical element 104 (lens 104).
The new system 100 and method 600 enables a better edge transition between the transmissive aperture 108 and the high reflective coating 106. The new system 100 and method 600 creates a very sharp and well defined transition, were the prior art's ion milling process resulted in a gradual transition over a longer spatial distance due to the masking and milling process.
The new system 100 and method 600 enables the formation of a better surface finish on the transmissive aperture 108 of the optical element 104 (lens 104). The prior art's ion milling process degrades the surface finish and can create a haze on the surface if milled too deep.

Although multiple embodiments of the present invention have been illustrated in the accompanying Drawings and described in the foregoing Detailed Description, it should be understood that the invention is not limited to the disclosed embodiments, but is capable of numerous rearrangements, modifications and substitutions without departing from the invention as set forth and defined by the following claims. It should also be noted that the reference to the “present invention” or “invention” used herein relates to exemplary embodiments and not necessarily to every embodiment that is encompassed by the appended claims.

1. An optic obscuration assembly for holding an optical element, the optic obscuration assembly comprising:
a back cover comprising a magnet holder, where the magnet holder is configured to hold a magnet; and
an optical element cell, connected to the back cover, within which there is held the optical element such that a front surface of the optical element is exposed and a back surface of the optical element is located a predetermined distance from the magnet.

2. The optic obscuration assembly of claim 1, further comprising:
a spring flexure ring, located between the back cover and the optical element cell, that supports an outer perimeter of the back surface of the optical element; and
a spring flexure device which comprises a plurality of spring flexures each having an outer end in contact with the spring flexure ring, where the plurality of spring flexures are configured to apply an axial force through the spring flexure ring to the optical element.

3. The optic obscuration assembly of claim 2, wherein the spring flexure device further comprises a support ring, where each spring flexure has an inner end attached to the support ring and the outer end in contact with the spring flexure ring.

4. The optic obscuration assembly of claim 2, further comprising:
a spring plunger which has a first end attached to the optical element cell and a second end that contacts an outer diameter of the optical element;
two support pins which are secured to the optical element cell and positioned to contact the outer diameter of the optical element; and
the spring plunger is configured to apply a radial force to the optical element.

5. The optic obscuration assembly of claim 4, wherein the spring flexures, the spring flexure ring and the spring plunger are configured to apply both the axial force and the radial force to the optical element such that the optical obscuration assembly is allowed to grow and shrink with temperature changes without inducing strain on the optical element.

6. The optic obscuration assembly of claim 1, further comprising two support pins exposed on an outer surface of the optical cell element.

7. A system for working on an optical element, the system comprising:
an optic obscuration assembly configured to hold the optical element which does not have a reflective coating thereon, the optic obscuration assembly comprising:
a back cover comprising a magnet holder, where the magnet holder is configured to hold a magnet; and
an optical element cell, connected to the back cover, within which there is held the optical element such that a front surface of the optical element is exposed and a back surface of the optical element is located a predetermined distance from the magnet;
a positioning system configured to place a metal obscuration on a predetermined position of the front surface of the optical element while the optical element is held in the optic obscuration assembly and the magnet holds the metal obscuration in the predetermined position on the optical element;
a coating system configured to deposit a reflective coating onto at least an exposed portion of the front surface of the optical element while the optical element is held in the optic obscuration assembly and the magnet holds the metal obscuration in the predetermined position on the optical element; and
wherein after the reflective coating is deposited onto the optical element the metal obscuration is removed from the front surface of the optical element and the optical element is removed from the optic obscuration assembly such that the removed optical element has the reflective coating located thereon and a transmissive aperture located in the predetermined position where the metal obscuration was originally placed and subsequently removed from.

8. The system of claim 7, wherein the optic obscuration assembly further comprises:
a spring flexure ring, located between the back cover and the optical element cell that supports an outer perimeter of the back surface of the optical element; and
a spring flexure device which comprises a plurality of spring flexures each having an outer end in contact with the spring flexure ring, where the plurality of spring flexures are configured to apply an axial force through the spring flexure ring to the optical element.

9. The system of claim 8, wherein the spring flexure device further comprises a support ring, where each spring flexure has an inner end attached to the support ring and an outer end in contact with the spring flexure ring.

10. The system of claim 8, wherein the optic obscuration assembly further comprises:
a spring plunger which has a first end attached to the optical cell element and a second end that contacts an outer diameter of the optical element;
two support pins which are secured to the optical cell element and configured to contact the outer diameter of the optical element; and
the spring plunger is configured to apply a radial force to the optical element.

11. The system of claim 10, wherein the spring flexures, the spring flexure ring and the spring plunger are configured to apply both the axial force and the radial force to the optical element such that the optical obscuration assembly is allowed to grow and shrink with temperature changes that occur during the coating step without inducing strain on the optical element.

12. The system of claim 8, wherein the positioning device further comprises:
a video inspection system configured to determine the predetermined position on the front surface of the optical element; and
an x/y/z micrometer driven stage with a vacuum wand attached thereto where the vacuum wand uses a vacuum to hold the metal obscuration while placing the metal obscuration onto the predetermined position of the front surface of the optical element.

13. A method for working on an optical element, the method comprising the steps of:
providing the optical element which does not have a reflective coating thereon;
providing an optic obscuration assembly for holding the optical element, the optic obscuration assembly comprising:
a back cover comprising a magnet holder, where the magnet holder is configured to hold a magnet; and
an optical element cell, connected to the magnet holder, within which there is held the optical element such that a front surface of the optical element is exposed and a back surface of the optical element is located a predetermined distance from the magnet;
placing a metal obscuration on a predetermined position of the front surface of the optical element while the optical element is held in the optic obscuration assembly and the magnet holds the metal obscuration in the predetermined position on the optical element;
depositing a reflective coating onto at least an exposed portion of the front surface of the optical element while the optical element is held in the optic obscuration assembly and the magnet holds the metal obscuration in the predetermined position on the optical element;
removing the metal obscuration from the front surface of the optical element; and
removing the optical element from the optic obscuration assembly, wherein the removed optical element has the reflective coating located thereon and a transmissive aperture located in the predetermined position where the metal obscuration was originally placed and subsequently removed from.

14. The method of claim 13, wherein the optic obscuration assembly further comprises:
a spring flexure ring, located between the back cover and the optical element cell that supports an outer perimeter of the back surface of the optical element; and
a spring flexure device which comprises a plurality of spring flexures each having an outer end in contact with the spring flexure ring, where the plurality of spring flexures are configured to apply an axial force through the spring flexure ring to the optical element.

15. The method of claim 14, wherein the spring flexure device further comprises a support ring, where each spring flexure has an inner end attached to the support ring and the outer end in contact with the spring flexure ring.

16. The method of claim 14, wherein the optic obscuration assembly further comprises:
a spring plunger which has a first end attached to the optical cell element and a second end that contacts an outer diameter of the optical element;
two support pins which are secured to the optical cell element and positioned to contact the outer diameter of the optical element; and
the spring plunger is configured to apply a radial force to the optical element.

17. The method of claim 16, wherein the spring flexures, the spring flexure ring and the spring plunger are configured to apply both the axial force and the radial force to the optical element such that the optical obscuration assembly is allowed to grow and shrink with temperature changes that occur during the coating step without inducing strain into the optical element.

18. The method of claim 14, wherein the placing step further comprises:
determining the predetermined position on the front surface of the optical element; and
moving a vacuum wand which uses a vacuum to hold the metal obscuration while placing the metal obscuration onto the predetermined position of the front surface of the optical element.

19. An optical element which has a reflective coating located on a front surface thereof and a non-ion milled transmissive aperture at a predetermined position of the front surface, and wherein the non-ion milled transmissive aperture is surrounded by the reflective coating.

20. The optical element of claim 19, wherein the optical element is a concave optical element, a plano optical element, or a convex optical element.
